(19) United States
(12) Patent Application Publication
(10) Pub. No.: US 2006/0041887 A1
(43) Pub. Date: Feb. 23, 2006

(54) Expert system for solution management

(75) Inventor: Joseph M. Dusio, Cedar Rapids, IA (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Intermec IP Corp., Everett, WA (US)

(21) Appl. No.: 11/232,501

(22) Filed: Sep. 22, 2005

Related U.S. Application Data
(63) Continuation-in-part of application No. 10/909,924, filed on Aug. 2, 2004.
Application No. 10/909,924 is a continuation-in-part of application No. 10/623,484, filed on Jul. 18, 2003.
Application No. 10/909,924 is a continuation-in-part of application No. PCT/US03/22551, filed on Jul. 18, 2003.
(60) Provisional application No. 60/396,982, filed on Jul. 18, 2002.
(60) Provisional application No. 60/396,982, filed on Jul. 18, 2002.
(60) Provisional application No. 60/492,021, filed on Aug. 2, 2003.
(60) Provisional application No. 60/615,572, filed on Oct. 2, 2004.
(60) Provisional application No. 60/613,091, filed on Sep. 25, 2004.

(51) Int. Cl. G06F 9/46

(52) U.S. Cl. 718/100

(57) ABSTRACT

A plurality of roles associated with a solution are defined in a communication network. The solution is then instantiated by assigning specific devices and functionality to each of the plurality of roles associated with the solution. Communications are then monitored between the specific devices assigned to the plurality of roles to assess the performance of the solution.

### CROSS-REFERENCE TO RELATED APPLICATION(S)

This application is a continuation-in-part of U.S. application Ser. No. 10/909,924 filed Aug. 2, 2004 for “Enhanced System Management and User Assistance Through Software Monitoring” by J. Dusio, which in turn:

is a continuation-in-part of U.S. application Ser. No. 10/623,484 filed Jul. 18, 2003 for “Indicator for Communicating System Status Information” by Richard Mahany, Ronald Mahany, J. Bandringa and J. Dusio, which in turn claims the benefit of Provisional Application No. 60/396,982 filed Jul. 18, 2002 for “System and Method for Communicating the Degree of System Readiness for a Non-Technical User” by Richard Mahany, Ronald Mahany and J. Bandringa,

is a continuation-in-part of PCT Application No. PCT/US03/22551 filed Jul. 18, 2003 for “Indicator for Communicating System Status Information” by Richard Mahany, Ronald Mahany, J. Bandringa and J. Dusio, which in turn claims the benefit of Provisional Application No. 60/396,982 filed Jul. 18, 2002 for “System and Method for Communicating the Degree of System Readiness for a Non-Technical User” by Richard Mahany, Ronald Mahany and J. Bandringa, and

claims the benefit of Provisional Application No. 60/492,021 filed Aug. 2, 2003 for “Enhanced System Management and User Assistance Through Software Monitoring” by J. Dusio.

This application also claims the benefit of Provisional Application No. 60/615,572 filed Oct. 2, 2004 for “System and Method for Solution Management” by J. Dusio, and of Provisional Application No. 60/613,091 filed Sep. 25, 2004 for “System and Method for Solution Management” by J. Dusio.

### INCORPORATION BY REFERENCE

The aforementioned Provisional Application Nos. 60/615,572, 60/613,091, 60/492,021 and 60/396,982, U.S. application Nos. 10/909,924 and 10/623,484, and PCT Application No. PCT/US03/22551 are hereby incorporated by reference in their entirety.

### BACKGROUND OF THE INVENTION

Management software is designed by providers of digital communication networking technology to monitor the operation of computer devices in the digital communication network. This management software is employed to ensure that solutions operating on the network are continually available without interruption, which is a requirement in a number of business environments.

Management software is typically built on a model of device management, in which the function and operation of particular devices are monitored by a management software console from a location that is remote from the devices. Most of these types of applications begin by managing a single device at a time. Management activities at this level include file downloads, configuration parameters and some indication of device readiness or status.

Additional levels of support can be provided by expanding device management to system or enterprise management. This expanded management capability is provided by monitoring multiple devices or groups of devices, aggregating status information and providing advanced reporting features.

Although management software at the system and enterprise management levels has been well received by users of digital communication network systems, further improvement in the software's ability to provide monitoring services that are focused on the solutions employed by the user are desirable.

### BRIEF SUMMARY OF THE INVENTION

The present invention is a method of monitoring a solution in a communication network, in which a plurality of roles associated with the solution are defined. The solution is then instantiated by assigning specific devices and functionality to each of the plurality of roles associated with the solution. Communications are then monitored between the specific devices assigned to the plurality of roles to assess the performance of the solution.

### BRIEF DESCRIPTION OF THE DRAWINGS

FIG. 1 is a diagram illustrating a digital communication network having components defined as “fixed/static” or “roaming/transient” according to a prior art definition scheme.

FIG. 2 is a diagram illustrating a digital communication network having components defined as “solution static” or “solution transient” according to a solution management definition scheme of an embodiment of the present invention.

FIG. 3 is a diagram illustrating an exemplary template that defines device roles in a solution according to an embodiment of the present invention.

FIGS. 4-10 are diagrams illustrating potential solution templates that are selectable by a user.

FIG. 11 is a diagram illustrating a graphical user interface (GUI) for instantiating a solution template according to an embodiment of the present invention.

FIG. 12 illustrates exemplary operation of an expert system on a fully instantiated solution template.

FIG. 13 is a diagram illustrating a process by which an expert system can adapt its test strategies based on past test results.

FIG. 14 is a diagram illustrating a live display of templates where a box has been checked denoting that failures have been reported in certain solutions.

### DETAILED DESCRIPTION

In the context of digital communication networking technology, a “solution” is the set of hardware and software components that perform a particular business activity. This definition includes, for example, a single communication session between a handheld computer and a host computer, the software employed on both computers to support the session, and the communication infrastructure between the two computers. Solutions often include optional components such as access points and peripheral devices such as printers, scanners, and the like. Thus, according to this definition, individual devices such as host computers, access points, printers, etc. typically participate in multiple solutions. A handheld computer participates in one solution for each of its active communication sessions.

Defining a “solution” in this manner means that multiple solutions exist for any particular installation of hardware and software. As a result, the solution definition is able to closely emulate the customer's operational model. For example, a user experiencing difficulties with a solution on a network typically reports problems such as “can't connect with the host” or “slow response time to the host,” which are problems related to a particular activity (or solution). The set of components or devices defined as a “solution” represents the smallest granularity in which users find and report problems, which makes the solution definition the best choice for building the structure of a monitoring system.

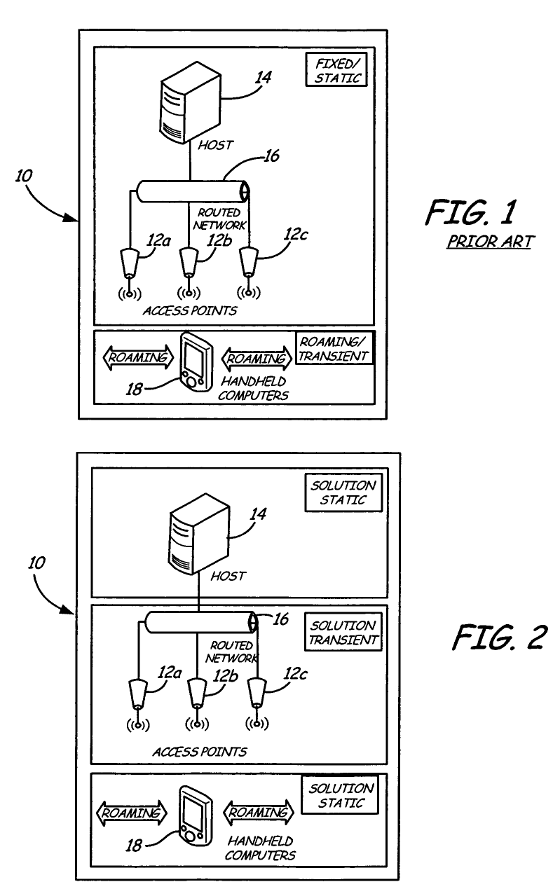

FIG. 1 is a diagram illustrating digital communication network 10 having components defined as “fixed/static” or “roaming/transient” according to a prior art definition scheme. Network 10 includes access points 12a, 12b and 12c connected to host computer 14 via routed network 16. Handheld computers, such as handheld computer 18, communicates with host computer 14 via one of access points 12a, 12b and 12c when located in a zone that is serviced by the access point. Access points 12a, 12b and 12c sustain a communication session between host computer 14 and handheld computer 18 as handheld computer 18 moves out of radio range of one access point and into the radio range of another access point. This activity, often called “roaming,” defines the types of devices in network 10, with devices that have roaming capability being characterized as “roaming/transient” devices, and devices that devices that are not physically movable being characterized as “fixed/static” devices. In the example shown in FIG. 1, handheld computer 18 is a roaming/transient device, while access points 12a, 12b and 12c and host computer 14 are fixed/static devices.

The definition of devices shown in FIG. 1 does not allow characterization of components or groups of components by “solution.” A different definition scheme must be used in order to allow management of devices according to the solution(s) in which they participate.

FIG. 2 is a diagram illustrating digital communication network 10 having components defined as “solution static” or “solution transient” according to a solution management definition scheme of an embodiment of the present invention. Solution static devices are defined as devices that will always be a part of a solution (where a solution is a communication session carried out with a handheld computer). Solution transient devices are defined as devices that sometimes participate in a solution, but do not necessarily need to be involved in a particular solution. Thus, in network 10 shown in FIG. 2, host computer 14 and handheld computer 18 are categorized as solution static devices, while access points 12a, 12b and 12c are categorized as solution transient devices. The structure of network 10 is identical to the structure shown in FIG. 1, but the categorization of devices has changed from a device management paradigm to a solution management paradigm.

The diagram of FIG. 2 is somewhat counterintuitive, because of the fact that fixed network infrastructure and access points are characterized as “transient,” while mobile handheld computers are characterized as “static.” This confusion is dispelled when the frame of reference is changed from physical movement to participation in communication sessions. Host computer 14 and handheld computer 18 are considered to be “solution static” because they are always present in a solution, even when roaming occurs. Access points 12a, 12b and 12c are “solution static” because any particular access point may or may not be participating in a solution as roaming occurs. Likewise, network infrastructure devices (shown as routed network 16) are likely to participate in solutions intermittently because those devices form different communication pathways based on factors that change in real time and are beyond the control of the user.

In order to establish the roles of particular devices in a solution, some definition of device functionality must be provided for the management software. This definition is provided by a template that sets forth the “roles” that are fulfilled by devices for a particular solution. For example, many solutions include the following roles:

Primary terminal

Middleware

Host computer

Communication pathway between host computer and middleware

Communication pathway between middleware and primary terminal

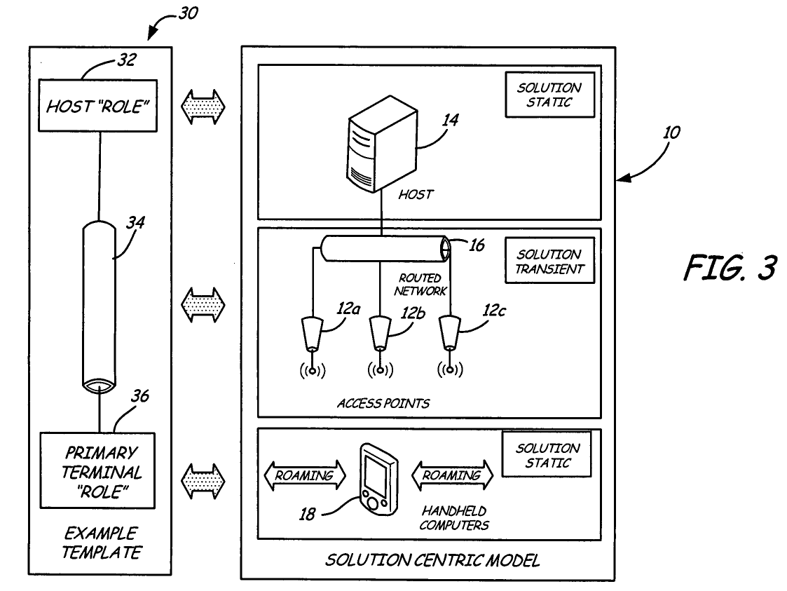

FIG. 3 is a diagram illustrating exemplary template 30 that defines device roles according to an embodiment of the present invention. Template 30 includes host role 32, data path function 34, and primary terminal role 36. This is a very simple solution structure; alternative templates may include additional roles such as peripherals, middleware, or others. FIG. 3 also illustrates an example of devices that can be selected to populate the roles set forth by template 30. The example shown in FIG. 3 corresponds to the devices shown in FIG. 2, with host computer 14 populating host role 32, access points 12a, 12b and 12c and routed network 16 providing data path function 34, and handheld computer 18 populating primary terminal role 36. In an exemplary embodiment, “solution static” devices are represented in the template by roles, while “solution transient” devices simply are grouped together in a way that provides other functionality that is defined in the template. The solution transient devices are specified in a more general, abstract manner because of the fact that the implementation can change (making it difficult or impossible to define the devices with specificity and lasting accuracy) and the fact that the particular implementation is not important to the execution of the solution.

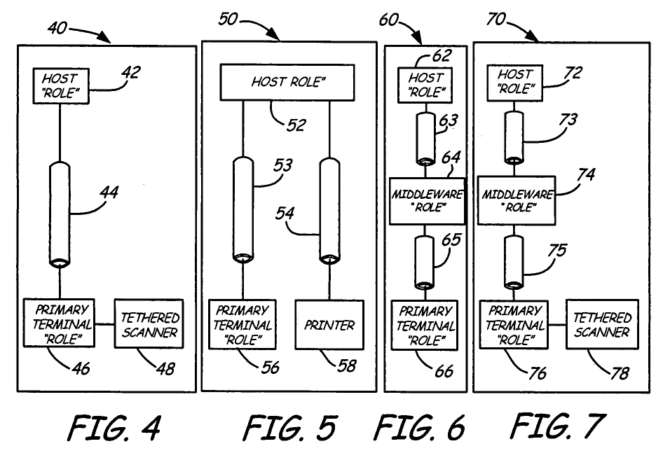

In a particular exemplary embodiment, a user controlling the operation of management software according to the present invention is able to create custom solution templates and/or select a solution template from a plurality of possible templates that have already been created. FIGS. 4-10 are diagrams illustrating potential templates that are selectable by a user, such as by a graphical menu in one embodiment. The templates can be created based on the devices and network configurations that need to be supported, so that any number of different configurations can be managed.

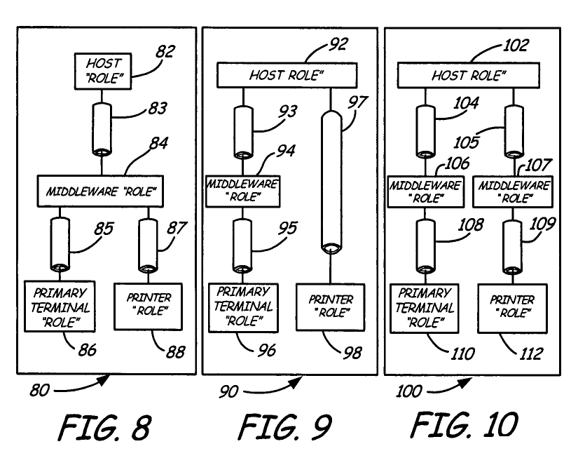

FIG. 4 illustrates template 40, which includes host role 42, data path function 44, primary terminal role 46 and tethered scanner role 48. FIG. 5 illustrates template 50, which includes host role 52, data path functions 53 and 54, primary terminal role 56 (communicating with host role 52 via data path function 53), and printer role 58 (communicating with host role 52 via data path function 54). FIG. 6 illustrates template 60, which includes host role 62, data path function 63, middleware role 64, data path function 65, and primary terminal role 66. FIG. 7 illustrates template 70, which includes host role 72, data path function 73, middleware role 74, data path function 75, primary terminal role 76 and tethered scanner role 78. FIG. 8 illustrates template 80, which includes host role 82, data path function 83, middleware role 84, data path function 85, primary terminal role 86 (communicating with middleware role 84 via data path function 85), data path function 87, and printer role 88 (communicating with middleware role 84 via data path function 87). FIG. 9 illustrates template 90, which includes host role 92, data path function 93, middleware role 94, data path function 95, primary terminal role 96 (communicating with middleware role 94 via data path function 95), data path function 97, and printer role 98 (communicating with host role 92 via data path function 97). FIG. 10 illustrates template 100, which includes host role 102, data path functions 104 and 105, middleware roles 106 and 107 (communicating with host role 102 via data path functions 104 and 105, respectively), data path functions 108 and 109, primary terminal role 110 (communicating with middleware role 106 via data path function 108), and printer role 112 (communicating with middleware role 107 via data path function 109). Other devices, such as RF/ID devices or others, may also be supported by a template that is either provided as an option to a user or can be included in a customized template.

The management software of the present invention automatically creates logical assertions that apply to the roles defined by a template. For example, template 40 shown in FIG. 4 includes host role 42, data path function 44, primary terminal role 46 and tethered scanner role 48. The management software automatically configures its logic to apply specifically to the management of these roles and the interconnections between them, as the software has been designed to account for the capabilities and functions that are associated with each of these roles. Templates are created by assembling roles selected from a library in a unique manner, and in one embodiment the management software automatically creates logical assertions that apply to each of the selected roles dynamically, as the template is assembled.

The management software may be configured to specifically monitor and manage interactions between the software associated with each of the defined roles in a solution. Some examples of management through software are disclosed in U.S. application Ser. No. 10/909,924, which has been incorporated herein by reference.

The various roles depicted in the templates of FIGS. 4-10 are not instantiated; in other words, there is no association between actual devices and roles in the templates. For example, a template that has a printer role only implies that the solution includes the capability of printing. That capability can be realized by any number of different printer models with varying capabilities. The model and capabilities of the printer are not known until the printer role is instantiated.

The process of instantiating the roles within a selected template will typically be performed by a user. The user first selects a template that best describes the solution (i.e., business hardware/software installation) that is being used. Once a template is selected, the user assigns particular devices to each role to instantiate the template.

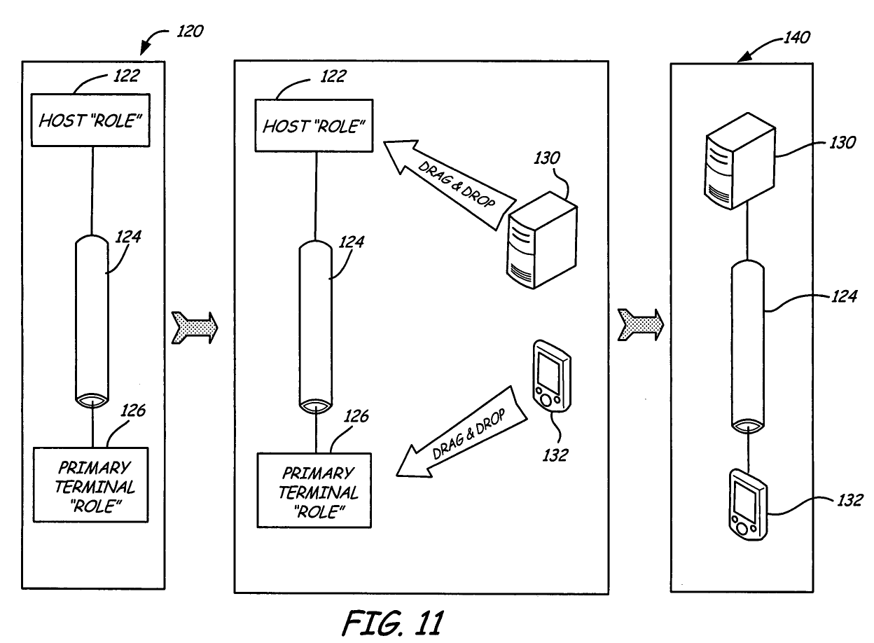

FIG. 11 is a diagram illustrating a graphical user interface (GUI) for instantiating a solution template according to an embodiment of the present invention. First, template 120 is selected that describes a user's solution. Template 120 includes host role 122, data path function 124, and primary terminal role 126. Next, template 120 is instantiated by dragging and dropping selected devices into the roles that are graphically depicted by template 120. In the example shown in FIG. 11, host computer 130 is selected, dragged and dropped into host role 122, and handheld computer 132 is selected, dragged and dropped into primary terminal role 126. The result is fully instantiated template 140, having host computer 130 connected to handheld computer 132 via data path function 124.

Fully instantiated template 140 defines the user's solution and provides details about the user's expectations for the solution. Monitoring of solution static roles is achieved by testing the operational status of the devices that substantiate those roles. Template functionality that is realized by solution transient devices such as communication pathways may be assessed in real time to ensure that the required value is being provided to the solution, regardless of how that functionality is achieved.

Once the template has been instantiated, management software operates to determine whether the solution being monitored is functioning properly, and to locate the cause of any problems that are detected. The detection of problems is preferably tied closely to the user's expectations for the solution. This capability is achieved by the process of user selection and instantiation of a graphical template, because the definition of the solution and of the user's expectations for the solution and its desired operation are specified by the fully instantiated template. The identity and all known details of the devices of the solution are specified by the fully instantiated template, as well as the definition of the roles played by each device and how the devices should be connected. When exiting the environment where the user is allowed to select and instantiate a template, the management software encodes logical assertions and inserts them into its knowledge base so that the information associated with the solution can be used.

In an exemplary embodiment, solution management software performs monitoring functions that detect solution failure independent of whether a user has noticed and reported the failure. This monitoring is preferably performed by an expert system, which is a computer program that contains a knowledge base and a set of algorithms that infer new facts from knowledge and from incoming data. By tying the monitoring functions performed by the expert system to the fully instantiated template that defines a solution, “false negative” failure reports can be avoided. For example, if an access point or a network router fails, an error report will not be issued if that particular device is not part of the active communication pathway for the solution being monitored. If the solution is able to function properly, the failure report is not needed, and the time and money that would otherwise be spent on non-productive activities (that is, activities that are not related to the business functions that are performed by the solution) is saved.

In an exemplary configuration of the management software, automated troubleshooting is performed by selectively performing Internet protocol (IP) tool suite commands to determine whether devices defined by the fully instantiated template are functioning properly. The use of IP based tools has the distinct advantage of accessing the dynamic routing mechanism that is inherent in distributed IP Internet works. Examples of these commands are as follows:

1. Traceroute

A traceroute command provides the list of IP hosts between the sending host and the target. Various statistics describing the amount of time for each hop between IP hosts in the path between the sender and target are often also available.

It is significant that the traceroute command tests the IP pathway between the sender and target. It is a goal of troubleshooting to determine the viability of the pathway between the primary terminal and the host computer. Since the pathway between the terminal and host is achieved through use of the IP suite, a test that employs the same pathway will be accurate where other methods such as are employed in message passing systems (which choose a “best” route that could be different from the route an IP packet would travel) would not.

The intended use of the traceroute command is for the management software console to send a message to each of the automated data collection (ADC) solution components, requiring them to perform a traceroute command to another ADC solution component and report the results to the management software console. In this way the management software console can send a single message to compel the handheld computer to respond with the current IP internetwork pathway to the host computer. Such results will enumerate all the access points, routers and switches that are required to create the end-to-end connection between the primary terminal and the host. Similarly, the printer could be compelled to send a similar message to the host or middleware computer to “discover” that IP based pathway.

2. Ping

A ping command provides the sender with information about whether or not the targeted IP device is reachable and how long it takes to contact that device.

It is significant that ping tests the IP pathway between the sender and target. It is a goal of troubleshooting to determine the viability of the pathway between the primary terminal and the host computer. Since the pathway between the terminal and host is achieved through use of the IP suite, a test that employs the same pathway will be accurate where other methods such as message passing would not.

The intended use of the ping command is for the management software console to send a message to each of the ADC solution components requiring them to perform a ping command to another ADC solution component and report the results to the management console. In this way the management console can send a single message to compel the handheld computer to respond with an indication if and how well the primary terminal can communicate with the host computer. Similarly the printer could be compelled to determine if that required end-to-end connection exists.

3. Traceroute Relay

This message and facility is designed to enable troubleshooting when the console can not communicate directly with a specific solution component. Any solution component receiving this message will serve as a proxy agent between the requesting console and the targeted solution component. The receiving component will send a copy of this message to the targeted solution component, which will then perform the traceroute command as required by the console. The message itself must contain all the parameters for the targeted component to execute the traceroute command.

The targeted component will create a response message based upon the response to the traceroute command and send that message back to the relay component. Upon receipt of the response message, the relay component will forward that message to the console. This method is chosen because the path between the targeted component and the console is unproven or unreliable.

4. Ping Relay

This message and facility is designed to enable troubleshooting when the console can not communicate directly with a specific solution component. Any solution component receiving this message will serve as a proxy agent between the requesting console and the targeted solution component. The receiving component will send a copy of this message to the targeted solution component, which will then perform the ping command as requested by the console. The message itself must contain all the parameters for the targeted component to execute the ping command.

The targeted component will create a response message based on the response to the ping command and send that message back to the relay component. Upon receipt of the response message, the relay component will forward that message to the console. This method is chosen because the path between the targeted component and the console is unproven or unreliable.

Fully instantiated templates have enough information to support expert system directed monitoring and analysis. In the example of the fully instantiated template shown in FIG. 11, the expert system could send either the primary terminal or the host a command to perform a traceroute command to the other device, provided that the communications pathway is operational and available. The results of that command can then be asserted into the knowledge base of the expert system for troubleshooting purposes.

The management software console periodically instructs the network devices of the solution being monitored to perform traceroute commands to learn and track the communication paths used in the solution. This path data is extremely valuable when the communication path of the solution is broken or intermittent. Statistical processing of the periodically gathered data provides the expert system with “fuzzy” information about which communication paths are most likely to be used. That information can be used by the expert system to determine which links in the communication path should be tested first.

The saved data path information may also be used to make knowledge base assertions about IP node adjacency which can be exploited as the expert systems creates and prioritizes test cases in troubleshooting efforts. In addition, the saved data path is useful to users because it determines the number of alternate communication paths, which is useful as a measure of fault tolerance available for a solution. The number of alternate paths also alerts the user to the number of different paths which were required to support continuous operation of the solution, which is a measure of the communication path requirements (or fragility) of the solution.

The expert system is best executed when it has access to the data associated with the management software console, such as for a system where the expert system is a module of the management software console product. However, regardless of were the expert system resides, challenges will be faced because of the fact that the expert system cannot be located on every device of a particular solution.

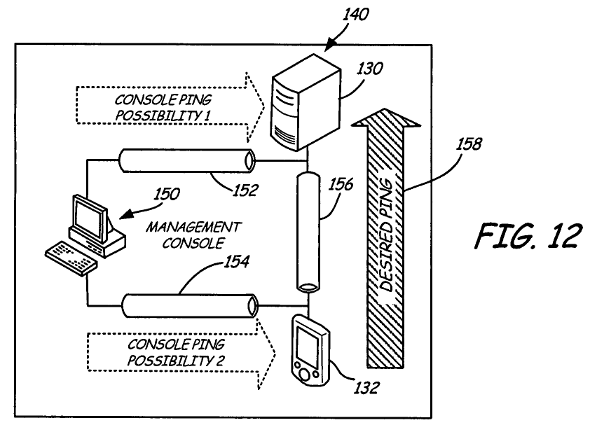

FIG. 12 illustrates exemplary operation of an expert system associated with management software console 150 on fully instantiated solution template 140 (which is also shown in FIG. 11). If the connectivity between handheld computer 132 and host computer 130 is suspected to be unavailable, then the best test is to have the primary terminal (handheld computer 132) perform a connectivity test to host computer 130. This test is usually performed with a ping command from either handheld computer 132 to host computer 130 or vice versa. However, the expert system that directs the ping command to be performed will almost certainly not be located on handheld computer 132 or host computer 130. If the expert system were to issue a ping command in the example shown in FIG. 12, it would test either communication pathway 152 or communication pathway 154. Neither of these possibilities tests the desired pathway, which is communication pathway 156 between handheld computer 132 and host computer 130.

In order to perform the connectivity test desired, which is shown in FIG. 12 as “desired ping” 158, management software console 150 sends a message to either handheld computer 132 or host computer 130 to instruct the receiving device to perform a ping command. The device that performs the ping command then returns the result of the command back to management software console 150, so that the expert system can incorporate this information into its knowledge base. The expert system is able to send the proper command because of the information it already knows about the devices of the solution from fully instantiated template 140.

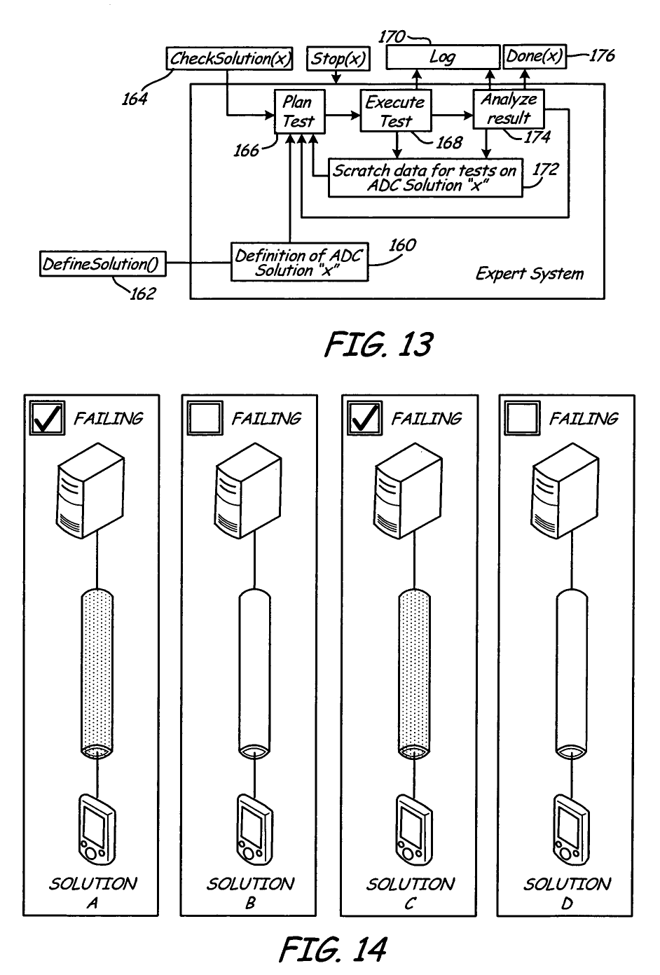

The expert system of the management software console is able to generate tests for execution to determine solution functionality based solely on the information provided by the fully instantiated template. However, it also possible in some embodiments for the expert system to selectively generates tests with a strategy that is based on the results of past tests. FIG. 13 is a diagram illustrating a process by which the expert system can adapt its test strategies based on past test results.

The process begins by asserting ADC solution definition 160 into the knowledge base of the expert system, as shown by box 162. At this point, the expert system can be instructed to “check” or test that solution, as indicated by box 164. Checking a solution involves generating tests to be executed on the actual solution components. Generating these tests occurs in “plan test” box 166. Once the expert system has planned the test strategy can created the appropriate tests, it begins to execute tests as shown in “execute test” box 168. Only a single test of the test strategy is performed in execute test box 168. During this phase, detailed information is added to the log about what is tested, why it is tested, and what can be learned from the test results. This step is shown by the arrow from execute test box 168 to log box 170. The test execution phase also stored information about the test it is performing in the knowledge base, as indicated by “scratch data for tests on ADC solution” box 172 and the arrow from box 172 to plan test box 166. The results of the test are then analyzed in “analyze result” box 174. The test results are added to the log (see the arrow between analyze result box 174 and log box 170) and into the knowledge base (see the arrow between analyze result box 174 and plan test box 166). If a solution is achieved, an indication is made to the host program, as indicated by “done” box 176.

At this point, one test action has been completed. However, instead of simply executing the next step in the original testing strategy (as initially determined in plan test box 166), the test planning system is invoked again in plan test box 166 to adapt the test strategy into a new strategy that incorporates information relating to the first test that was performed. This process is performed recursively so that an optimal test strategy can be formulated and executed, adapted to the knowledge learned about the actual ADC device as they are tested.

In an embodiment where fully instantiated templates are represented graphically, status information related to the status of solutions and the devices operating as part of those solutions can be represented directly on the fully instantiated template. For example, if a device is found by the expert system to be faulty, that device can be depicted in another color or in a different graphical style when viewing all solution templates in which the faulty device is present.

If an ADC device is determined to be in a “failed” state or otherwise unavailable, the expert system has the capability to process the communication path data and solution specifications to determine other solutions that rely on the failed device. Messages could be generated by the management software console to alert the console operator that other solutions are compromised or in jeopardy. In some embodiments, a property can be added to the primary terminal role of the solution(s) managed by the expert system to include the name and contact information of the user(s) of those solution(s), so that the management software console is able to automatically send notifications such as e-mail messages, web pages, etc. to the actual users of the system. This capability provides the users direct knowledge of the status of the solutions they utilize, which could increase their confidence in the overall management of their system and reduce the number of service calls placed by users. In addition, the expert system could command the readiness indicators of all the devices in an unavailable ADC solution to a particular value, such as “blinking” (of a light emitting diode) in one embodiment, to inform the user that the ADC solution is unavailable. This indication provides the user with a good idea of whether the job function can be performed with the devices available.

Under some circumstances the expert system will be unable to determine the cause of a problem. For example, if the management software console computer is removed from the network, it will not be able to successfully execute any tests and will therefore be unable to make a conclusion. In these circumstances, ADC solution information and testing logs can be assembled into an e-mail message and sent to a remote service center to speed time until the problem is resolved. This ability is even more useful if some tests have actually been completed when it is concluded that a resolution cannot be found. In this case, the information sent to the service center could be lengthy and could save a great deal of time and experimentation in trying to reproduce and understand the problem.

The information sent to the service center for analysis or further troubleshooting could include the definitions of the solution involved, the test strategies used, the tests performed and the results of those tests. This information can be transmitted electronically such as an attachment to an e-mail message. The transmitted information could then be inserted into a separate solution management console which is distinct from the customer's solution management console, and the data could be rendered graphically such that the graphical displays are identical to those seen at the customer's installation.

The roles defined in a template will support properties about that role. One simple example is that the “host computer” role could have a property which specifies the required version of software to run on the primary terminal role in order to work correctly with that host computer's application software. This is part of the solution definition, and therefore belongs in the template.

This “required terminal software version” information in the template could be leveraged to generate log messages that the primary terminal is not running the correct software. Furthermore, the expert system could cause the download of the correct version of software to the primary terminal because the required version information is known to the expert system via the template property. In this way, there would be no need to configure or maintain which versions of software should be sent to various devices. Another option is for the expert system to command a third party tool to send the correct version of information to the primary terminals. This is just one example of how the knowledge in a specification can be leveraged to make a time consuming manual process into an intelligent automatic process.

There are times when it is difficult to understand which component or components in a solution are causing a problem. The expert system can create test cases in a process of elimination strategy which can determine whether or not the problem follows a specific device.

A failed device that participates in multiple solutions has the ability to impact all those solutions at the same time. A troubleshooting service provider often receives multiple telephone calls reporting problems in this situation. The solution management software console could provide a graphical display of all the solutions. The troubleshooting service provider could then select the failed solutions as they are reported, and the expert system could use its logic and deduction ability to find the devices which are common to the solutions and begin automatically troubleshooting those devices.

FIG. 14 is a diagram illustrating the live display of templates where a box has been checked denoting that failures have been reported in certain solutions. This input is enough for the expert system to determine which devices are common to those solutions, to facilitate either automatic or manual troubleshooting.

In one exemplary embodiment, a user-selectable “Analyze” button (or another type of user input mechanism) may be provided on a display similar to the display shown in FIG. 14. Selection of the “Analyze” button by a user would instruct the expert system to initiate a troubleshooting routine that analyzes the managed solutions to determine which solutions are failing, determines the devices common to the failing solutions in order to identify which devices are failing, and provides a report to the user indicating the status (operating properly or failing) of devices that make up the managed solutions. This report may be graphical, similar to the display shown in FIG. 14, or may be provided as text or in some other format. The expert system's knowledge of the status of various solutions can be utilized to guide the process of testing the devices that make up each of the solutions, so that an accurate report of device status can be provided.

The present invention provides a solution management system that is able to monitor the performance of various devices in a communication network on a solution basis. In an exemplary embodiment, solutions are defined by selecting an appropriate template that includes roles that correspond to the roles of devices employed by the user's communication network. The template is then instantiated by defining the actual devices that fill each role of the template in the user's solution. The solution management system therefore has significant information about the devices that make up the user's solution, and is able to perform highly effective monitoring of the functionality of that solution. For example, identification of a single failed device by the solution management system can be extrapolated into an identification of all user-defined solutions that are affected by that device failure. Similarly, the failure of a device that does not affect the functionality of a solution is not identified as a problem that needs immediate attention.

In an exemplary embodiment, the solution management system is realized by an expert system that incorporates the definitions and results of monitoring tests into a knowledge base that is utilized in its decision making. In particular, the expert system can be utilized to iteratively adjust the monitoring tests that are performed based on the definitions and results of previous monitoring tests, in order to generate an optimum testing strategy that is most likely to detect a potential problem in a solution.

Although the present invention has been described with reference to preferred embodiments, workers skilled in the art will recognize that changes may be made in form and detail without departing from the spirit and scope of the invention.

1. A method of monitoring a communication network, comprising:
defining a plurality of roles associated with a solution that corresponds to a particular activity capable of being performed by the network;
instantiating the solution by assigning specific devices and functionality to each of the plurality of roles associated with the solution; and
monitoring communications between the specific devices assigned to the plurality of roles to assess performance of the solution.

2. The method of claim 1, wherein defining the plurality of roles associated with the solution comprises:
selecting a solution template from a list of available templates that most closely represents the solution.

3. The method of claim 1, wherein defining the plurality of roles associated with the solution comprises:
creating a custom solution template that represents the solution.

4. The method of claim 1, wherein instantiating the solution comprises:
selecting devices from a list of available devices in a graphical user interface, and assigning the selected devices into the roles defined for the solution.

5. The method of claim 1, wherein monitoring communications between the specific devices comprises:
performing test communications between specific devices of the solution.

6. The method of claim 4, wherein performing test communications between specific devices of the solution comprises:
generating a test plan that includes a plurality of test communications;
executing the plurality of test communications; and
adapting the test plan after execution of each of the plurality of test communications based on results of each of the plurality of test communications that has been performed.

7. The method of claim 1, further comprising:
performing the steps of defining, instantiating and monitoring for multiple solutions; and
automatically identifying specific devices that are common to solutions that are determined to be failing by the monitoring of communications.

8. The method of claim 7, further comprising:
analyzing a status (operating properly or failing) of the devices that make up the multiple solutions; and
generating a report that indicates the status of the devices that make up the multiple solutions.

9. The method of claim 1, wherein the plurality of roles associated with the solution are defined to include a software version identifier for determining whether devices assigned to the plurality of roles are running a software version that corresponds to the software identifier.

10. The method of claim 9, further comprising:
automatically commanding each device to download the software version that corresponds to the software identifier for each device upon determining that the device is running a software version that does not correspond to the software identifier.

11. The method of claim 9, further comprising:
automatically transmitting the software version that corresponds to the software identifier to each device upon determining that the device is running a software version that does not correspond to the software identifier.

12. A communication network comprising:
a plurality of devices, each of the plurality of devices having the ability to transmit and/or receive communications to/from at least one other device of the plurality of devices; and
expert system software operatively coupled to the communication network, the expert system software being executable to:
define a plurality of roles associated with a solution that corresponds to a particular activity capable of being performed by the communication network;
assign selected ones of the plurality of devices and selected functionality of the communication network to each of the plurality of roles associated with the solution; and
monitor communications between the devices assigned to the plurality of roles to assess performance of the solution.

13. The communication network of claim 12, wherein the plurality of devices comprises at least one of a host computer, an access point, a handheld computer, a barcode scanner, a printer, and an RF/ID device.

14. The communication network of claim 12, wherein expert system software comprises a graphical user interface for defining the plurality of roles associated with the solution and assigning the selected ones of the plurality of devices and selected functionality of the communication network to each of the plurality of roles associated with the solution.

15. The communication network of claim 14, wherein the graphical user interface is configured to allow a user to select a solution template from a list of available templates that most closely represents the solution.

16. The communication network of claim 14, wherein the graphical user interface is configured to allow a user to create a custom solution template that represents the solution.

17. The communication network of claim 12, wherein the expert system software monitors communications between the devices assigned to the plurality of roles to assess performance of the solution by performing test communications between the selected ones of the plurality of devices assigned to the roles of the solution.

18. The communication network of claim 17, wherein performing test communications between the selected ones of the plurality of devices assigned to the roles of the solution comprises:
generating a test plan that includes a plurality of test communications;
executing the plurality of test communications; and
adapting the test plan after execution of each of the plurality of test communications based on results of each of the plurality of test communications that has been performed.

19. The communication network of claim 12, wherein the expert system software is operable to determine a version of software running on each the plurality of devices and command the plurality of devices to download an updated version of software upon determining that the version of software running a device is outdated.

20. The communication network of claim 12, wherein the expert system software is operable for multiple solutions to:
analyze a status (operating properly or failing) of the devices that make up the multiple solutions; and
generate a report that indicates the status of the devices that make up the multiple solutions.
